(19) United States
(12) Patent Application Publication
(10) Pub. No.: US 2025/0215987 A1
(43) Pub. Date: Jul. 3, 2025

(54) INSERTION VALVE

(71) Applicant: Mueller International, LLC, Atlanta, GA (US)

(72) Inventors: David Latimore Hughes, JR., Signal Mountain, TN (US); Timothy J. Mitchell, Hixson, TN (US)

(21) Appl. No.: 18/402,465

(22) Filed: Jan. 2, 2024

(51) Int. Cl. F16K 27/04

(52) U.S. Cl. CPC F16K 27/044; F16K 2200/501

(57) ABSTRACT

An insertion valve comprises a first casing comprising a trunk bore defining a diameter, a second casing opposite the first casing, and a boss within the first casing and extending beyond the diameter of the trunk bore. In various aspects, the insertion valve can comprise a casing comprising a sleeve surrounding a trunk bore and a monolithic bridge directly coupled to the sleeve. Interlocking gasket can further comprise an annular seal component comprising a first notch diametrically opposed from a second notch and a wedge seal component comprising a first head coupled to the first notch and a second head coupled to the second notch.

### TECHNICAL FIELD

This disclosure relates to insertion valves. More specifically, this disclosure relates to bodies, flanges, and gaskets of insertion valves.

### BACKGROUND

Installation of insertion valves typically involves installing an insertion valve on a pressurized (or charged) pipe within a pipe system, such as a municipal water system. When the installation is complete, the insertion valve forms a bell and spigot joint at each side of the insertion valve. A lower cartridge body can be installed within a larger body or housing of the valve body of the insertion valve assembly to prevent water, gas, or other fluids from escaping from the charged pipe. When the pipe is captured within the valve body, the pipe is cut. Following installation, the two ends of the pipe can be captured within two opposed casings (e.g., an upper casing and a lower casing) that capture and surround the pipe ends and the lower cartridge body in a pair of bell and spigot joints.

In some applications, the newly formed loose ends can push and pull within the insertion valve, which may be caused by the movement of pipe elements upstream or downstream of the insertion valve in the pipe system and result in leaks at the loose ends of the cut pipe within the insertion valve. For example, tension formed in the laid pipe can result in separation over time of the bell and spigot joints formed by the loose ends of the pipe within the insertion valve. In other aspects, the pressure within the pipes can exacerbate the leaking at the valve, e.g., when the valve is cycled to a closed configuration.

Insertion valves commonly comprise a lower cartridge body inserted between the casings to capture a gate between the cut pipe ends that form the bell and spigot joints. The upper and lower casings extend from the lower cartridge body to capture the pipe ends and prevent the pipe from working into or out of the joint. Reducing the size of the valve, e.g., the pipe-capturing portions (arm or branch) of the valve, can reduce the prying force the pipe end exerts on the joint between the upper casing and the lower casing. For example, a typical water insertion valve comprises an upside-down “T” shape, where the monolithic bridges are formed on opposite sides of the “T.” The insertion valve is inserted through the vertical component (e.g., arm or branch) of the inverted “T” shape to permit or restrict flow from one end of the inverted “T” to the other end. The opposed casings capture the cut pipe in two opposed bell and spigot joints. This configuration can result in leaks or breaks due to the reacting bending forces of the pipe within the monolithic bridge and/or fluid pressure at the valve. Post-installation, the pipe can move too far into the valve. This configuration results in the pipe interfering with the operation of the valve and can result in increased bending forces that tend to separate the opposed casings of the valve body and damage the valve body. Leaks at the bell and spigot joint can result when the pipe separates from the valve body. Alternatively, post-installation, the pipe can move too far from the valve body, resulting in leaks at the bell and spigot joint and a tendency to pry apart the casings.

Because water valves can be rather large, molding a single gasket of sufficient size can also present challenges. Typically, designers will craft a series of gaskets that are joined in locations of reduced frequency of leakage occurring in the valve.

### SUMMARY

It is to be understood that this summary is not an extensive overview of the disclosure. This summary is exemplary and not restrictive, and it is intended to neither identify key or critical elements of the disclosure nor delineate the scope thereof. The sole purpose of this summary is to explain and exemplify certain concepts of the disclosure as an introduction to the following complete and extensive detailed description.

In one aspect, disclosed is an insertion valve comprising a first casing comprising a trunk bore defining a diameter, a second casing opposite the first casing, and a boss within the first casing and extending beyond the diameter of the trunk bore.

In a further aspect, disclosed is an insertion valve comprising a first casing and a second casing opposite the first casing. The first casing comprises a sleeve surrounding a trunk bore and a monolithic bridge directly coupled to the sleeve.

In yet another aspect, disclosed is an interlocking gasket comprising an annular seal component comprising a first notch opposed from a second notch and a wedge seal component comprising a first head coupled to the first notch and a second head coupled to the second notch.

Various implementations described in the present disclosure may comprise additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims. The features and advantages of such implementations may be realized and obtained by means of the systems, methods, features particularly pointed out in the appended claims. These and other features will become more fully apparent from the following description and appended claims or may be learned by the practice of such exemplary implementations as set forth hereinafter.

### BRIEF DESCRIPTION OF THE DRAWINGS

The accompanying drawings, which are incorporated in and constitute a part of this specification, illustrate several aspects of the disclosure and, together with the description, serve to explain various principles of the disclosure. The drawings are not necessarily drawn to scale. Corresponding features and components throughout the figures may be designated by matching reference characters for the sake of consistency and clarity.

FIG. 1 is a perspective view of an insertion valve assembly coupled to a pipe in accordance with one aspect of the current disclosure.

FIG. 2 is a perspective view of the insertion valve assembly of FIG. 1 with the pipe removed.

FIG. 3A is a perspective view of a cartridge comprising a bonnet and a lower cartridge body.

FIG. 3B is an exploded perspective view of the cartridge assembly of FIG. 3A.

FIG. 4 is a cross-sectional view of the insertion valve assembly of FIG. 1 taken along line 4-4.

FIG. 5 shows detail 5 shown in a cross-sectional view of the encircled portion of FIG. 4.

FIG. 6 shows a side-perspective view of the assembled encircled portion of detail 5 in FIG. 4.

FIG. 7 is a perspective view of the lower cartridge body of the insertion valve.

FIG. 8 is a perspective view of an assembled interlocking gasket for the lower cartridge body of the insertion valve.

FIG. 9 is an exploded view of the interlocking gasket of FIG. 8.

### DETAILED DESCRIPTION

The present disclosure can be understood more readily by reference to the following detailed description, examples, drawings, and claims, and their previous and following description. However, before the present devices, systems, and/or methods are disclosed and described, it is to be understood that this disclosure is not limited to the specific devices, systems, and/or methods disclosed unless otherwise specified, as such can, of course, vary. It is also to be understood that the terminology used herein is for the purpose of describing particular aspects only and is not intended to be limiting.

In one aspect, an insertion valve and associated methods, systems, devices, and various apparatuses are disclosed herein. Insertion valves typically begin as a tapping sleeve captured about a charged pipe and can add a new valve to a water or other fluid system. In other words, the insertion valve can be designed to add a valve to a pipe in a position where no valve previously existed, all while the pipe is fluidly charged and pressurized. In some aspects, the insertion valve can comprise a pair of opposed casings coupled to the pipe to form a tapping sleeve. A cutting tool is coupled to the tapping sleeve (e.g., valve body) to remove a portion of the pipe trapped between the inlet and outlet.

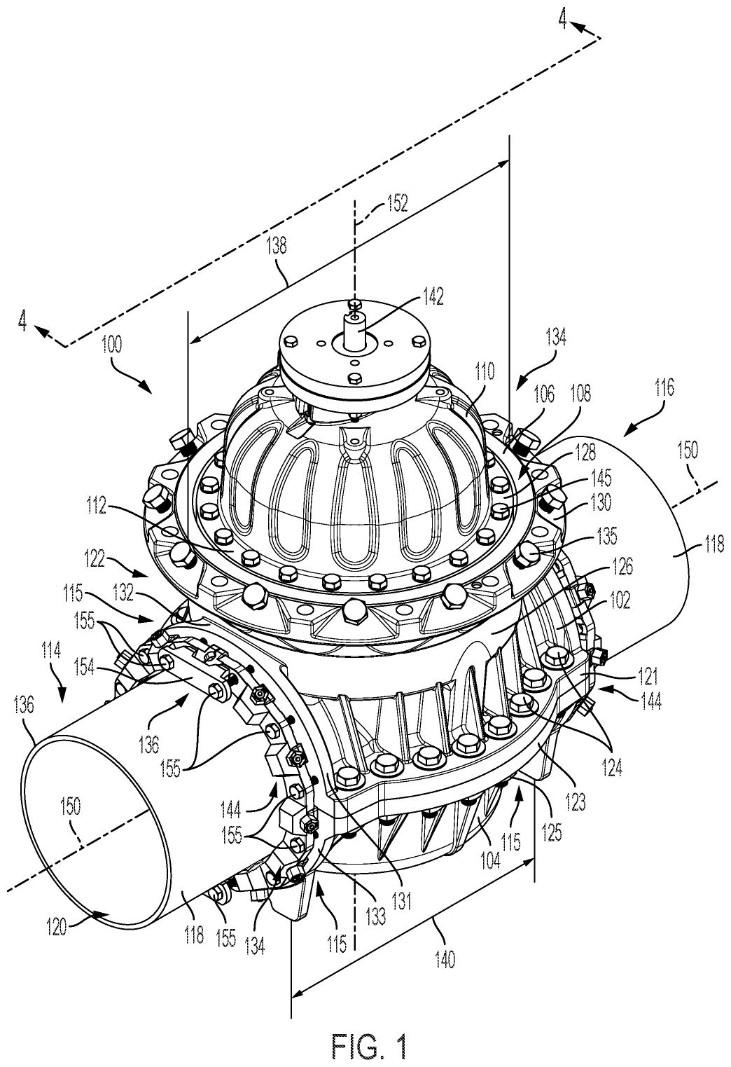

One aspect of an insertion valve 100 is disclosed and described in FIG. 1. Insertion valve 100 comprises a first, or upper casing 102, and a second, or lower casing 104. Upper casing 102 comprises a plurality of branches 115 on either side and interposed between an inlet 114 and an outlet 116. A flow direction or flow path 120 extends from inlet 114 to outlet 116 and can be defined by axis 150. Each branch 115 extends along axis 150 and perpendicular or transverse to trunk axis 152, defining trunk 106. The branches 115 are interposed between the inlet 114 and the outlet 116, and a branch along the transverse direction is described herein as trunk 106 and can define a trunk bore 108 therethrough.

The trunk 106 can extend upwards (e.g., perpendicular to axis 150) between an inlet 114 and an outlet 116 as defined by trunk axis 152 (e.g., extending along stem 142) to support a bonnet 110 that can be coupled to the upper casing 102 to seal a cartridge assembly 112. The cartridge assembly 112 can be coupled to the insertion valve 100 and support a lower cartridge body inside the upper casing 102 and the lower casing 104. The upper casing 102 and lower casing 104 form the inlet 114 and the outlet 116 that surround and support pipe 118 coupled to the insertion valve 100. When the insertion valve 100 is in an open configuration, the pipe 118 defines flow path 120 (e.g., extending along axis 150) through the insertion valve 100 from inlet 114 to the outlet 116. When the insertion valve 100 is in a closed configuration, the insertion valve 100 inhibits fluid communication between the inlet 114 and the outlet 116.

As used herein, upper casing 102 and lower casing 104 capture and surround pipe 118. In various aspects, the casings can be located at different orientations; for example, upper casing 102 can be on the right-hand side of pipe 118, and lower casing 104 can be on the left-hand side of pipe 118. That is, the upper casing 102 and lower casing 104 may not be oriented as shown in FIG. 1, but the relative top/bottom orientation can be used to indicate that the casings are opposed and capture pipe 118 in a clam-like configuration.

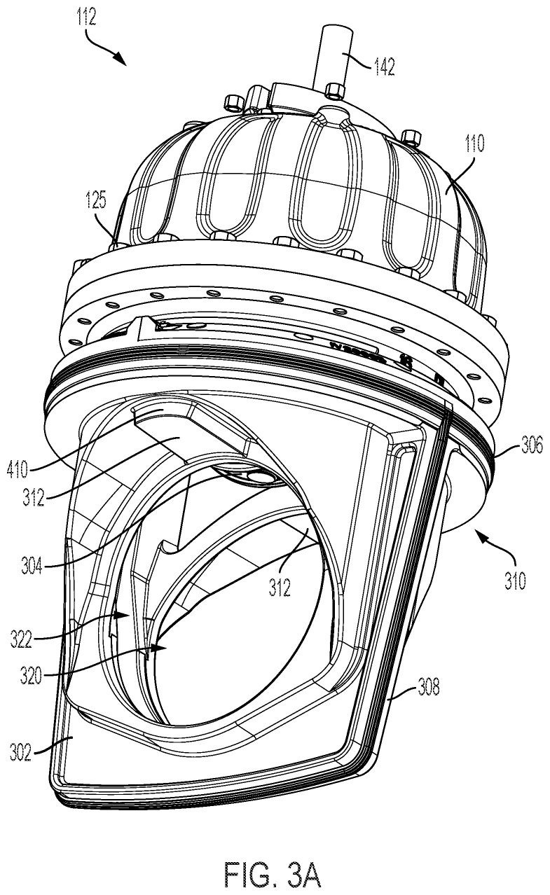

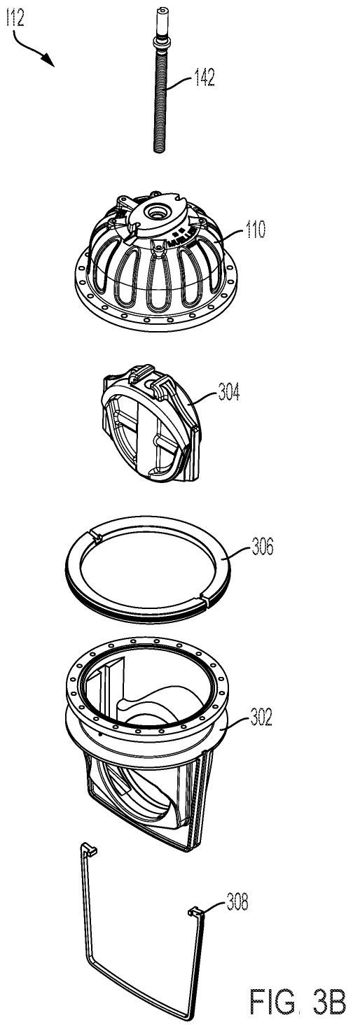

During installation, the upper casing 102 and lower casing 104 can be joined or coupled over an intact and fluidly charged pipe 118. As shown in FIG. 1, the upper casing 102 comprises an upper casing flange 121 coupled to a lower casing flange 123 of the lower casing 104, forming a valve body 122. Specifically, upper casing flange 121 can be coupled to lower casing flange 123, e.g., with various fasteners shown as bolts 124 and nuts 125, to create the valve body 122 around pipe 118. Before cutting and removing a central part, or “pipe coupon,” of the pipe 118, the valve body 122 can be referred to or function as a tapping sleeve. Generally, the tapping sleeve comprises branches 115 at the inlet 114 and the outlet 116, and trunk 126 that can support the cartridge assembly 112. The cartridge assembly 112 can comprise a lower cartridge body 302 (FIGS. 3-4 and 7) of the insertion valve 100. A bonnet flange 128 couples the bonnet 110 to the lower cartridge body 302 (FIGS. 3-4). During initial installation, bonnet 110 may not be present, and an attachment flange 130 can be configured to attach to a valve, such as a knife gate valve (not shown). A sealed cutting mechanism (not shown) mounted on the knife gate valve can cut the pipe 118 to remove the pipe coupon. In this way, the charged pipe 118 can be surrounded by a tapping sleeve (e.g., valve body 122 comprising the upper casing 102 and the lower casing 104), when the pipe 118 is cut and the pipe coupon is removed. In addition, the entire installation process of the insertion valve 100 can be performed while the pipe remains charged, e.g., under fluid dynamic pressure, by selectively opening and closing the knife gate valve during mounting, operation, and removal of the sealed cutting mechanism. Removal of the sealed cutting mechanism typically removes the pipe coupon as well.

In some aspects, fasteners such as bolts 124 can couple upper casing 102 to lower casing 104 to form valve body 122. Similarly, fasteners 145 can couple bonnet flange 128 of bonnet 110 to lower cartridge body 302 (FIGS. 3-4). Angled bolts 135 can have relatively larger heads than bolts 124 and/or fasteners 145 and function to attach and/or secure cartridge assembly 112 to upper casing 102. For example, angled bolts 135 can hold lower cartridge body 302 (FIGS. 3A-4) down to secure the cartridge assembly 112 relative to the valve body 122 (e.g., upper casing 102 and/or lower casing 104).

The valve body 122 can comprise an upper pipe flange 131 comprising a monolithic bridge 132 on the upper casing 102 and a lower pipe flange 133 on the lower casing 104. The upper pipe flange 131 and lower pipe flange 133 can each be defined and/or extend from the inlet 114 and/or the outlet 116 of the flow path 120 of the valve body 122. The monolithic bridge 132 can couple, bridge, and/or join the upper pipe flange 131 to the upper ridge or trunk 126 of the upper casing 102 on the assembled valve body 122. The monolithic bridge 132 can be integrally or monolithically formed with the upper casing 102 and interposed between the upper pipe flange 131 and the trunk 126 of the upper casing 102.

When assembled, valve body 122 couples to pipe 118 to form a bell and spigot joint 134. The bell and spigot joint 134 functions to restrain a pipe-end 136 (specifically, cut pipe end 418 in FIG. 4) within the monolithic bridge 132 and outside a trunk diameter 138. A distance between the monolithic bridge 132 of the inlet 114 to the monolithic bridge 132 of the outlet 116 can be defined as a lay-length 140 of valve body 122. For example, when the valve body 122 is formed, and upper casing 102 is securely coupled to lower casing 104, the valve body 122 can define a reduced lay-length 140 (e.g., by reducing the length of branches 115) that can effectively reduce installation time because the size of valve body 122 is reduced and the installation uses blind fasteners instead of through bolts. Additionally, the reduced lay-length 140 can reduce prying forces generated by the pipe 118 on the valve body 122 (e.g., tending to separate upper casing 102 from lower casing 104) to reduce wear and tear on the completed valve body 122.

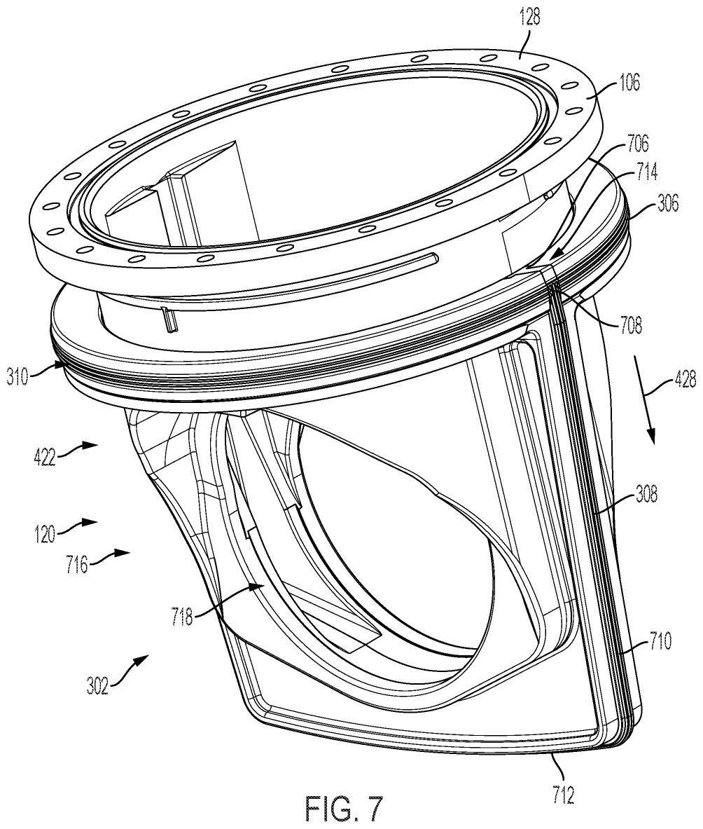

In various aspects, cartridge assembly 112 can comprise bonnet 110, lower cartridge body 302, a stem 142 that couples to gate 304 (FIGS. 3A-4), and an interlocking gasket 310 (e.g., annular seal component 306 and/or wedge seal component 308 shown in FIG. 7). stem 142 can move within bonnet 110, typically by turning or rotating, to open and close gate 304 within the lower cartridge body 302, and the lower cartridge body 302 can be sealed within the insertion valve 100 (FIGS. 3-4). In some aspects, a mechanical joint restraint, shown as restraint 144, can be coupled to the upper pipe flange 131 and/or the lower pipe flange 133 of the insertion valve 100 at the inlet 114 and/or outlet 116 of the valve body 122. In the current aspect, the restraint 144 can comprise two halves joined at retainers 154, e.g., on the upper casing 102 and/or the lower casing 104, to secure the restraint 144 around the inlet 114 and/or outlet 116 of the valve body 122. Blind fasteners, such as bolts 155, can couple the retainer 154 to the monolithic bridge 132 and the restraint 144 to the upper pipe flange 131.

The restraint 144 secures the insertion valve 100 relative to existing and/or installed pipe 118, e.g., installed and part of the overall piping system. Restraint 144 surrounds pipe 118 and securely couples to the upper pipe flange 131 and the lower pipe flange 133 of valve body 122 to pipe 118 and can, in some aspects, compress a gasket and seal the insertion valve 100 to pipe 118. Retainer 154 couples the ends of the restraint 144 and bolts 155 secure restraint 144 to the monolithic bridge 132. Blind fasteners or bolts 155 can couple restraint 144 against pipe flanges (e.g., 131 and 133) to compress a sealing gasket (not shown) captured therebetween.

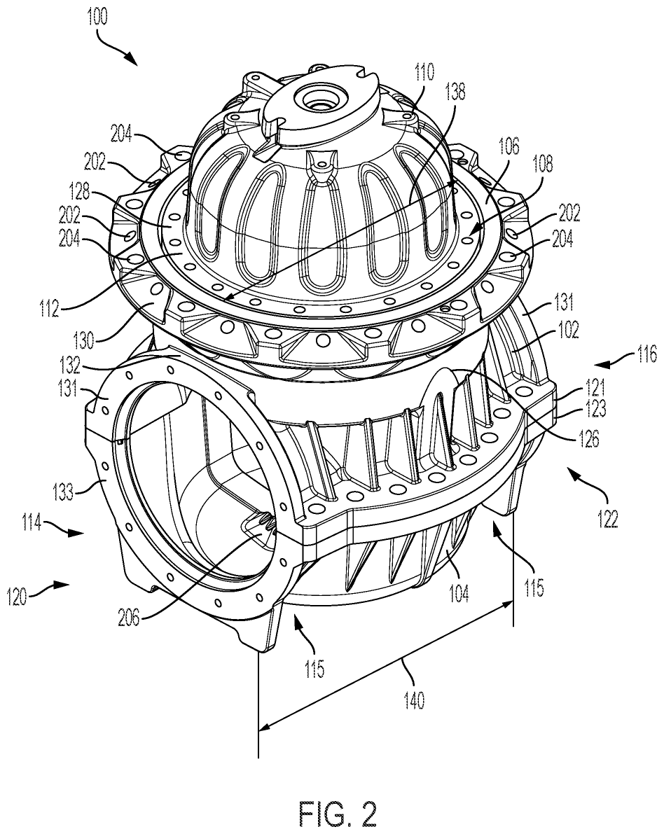

FIG. 2 is a perspective view of the insertion valve 100 of FIG. 1 with pipe 118 and fasteners removed. FIGS. 1 and 2 illustrate the joint that captures pipe 118 and forms the monolithic bridge 132. The pipe flanges (e.g., 131 and 133) couple to the restraint 144 to capture pipe 118 and prevent pipe 118 from moving axially (e.g., along axis 150 of FIG. 1) in the insertion valve 100.

Trunk 106 of the upper casing 102 can surround, form, and/or define the trunk bore 108. Monolithic bridges 132 (e.g., at inlet 114 and outlet 116) can be formed with the trunk 106 of the upper casing 102. Upper casing 102 and lower casing 104 form valve body 122 and can surround a cut end of pipe 118. That is, each casing (e.g., upper casing 102 and lower casing 104) partially surrounds pipe 118 coupled to insertion valve 100. In various aspects, the monolithic bridge 132 can reduce the lay-length 140 (e.g., the distance between the pipe flanges, e.g., upper pipe flange 131, at the inlet 114 to the outlet 116) by reducing the distance from the pipe flange 131 to the trunk 106. Trunk 106 can be formed integrally with and directly monolithically couple the monolithic bridge 132 to the trunk 106 to minimize the lay-length 140 of the insertion valve 100.

Trunk 106 and/or branches 115 can define an outer boundary and/or the exterior surface of valve body 122. In some aspects, trunk 106 can be directly coupled to monolithic bridge 132 to reduce the lay-length 140 of insertion valve 100. For example, monolithic bridge 132 can directly couple to the trunk 106 at the inlet 114 and/or outlet 116, e.g., to minimize the length of branches 115 and to minimize lay-length 140 of valve body 122, strengthen the upper pipe flanges 131, and improve the seal formed between upper casing 102 and lower casing 104. A lower lip 206 within an interior of the lower casing 104 can secure and align the lower cartridge body 302 supporting gate 304 (FIG. 3), e.g., to support gate 304 in the closed configuration and form a fluid-tight seal.

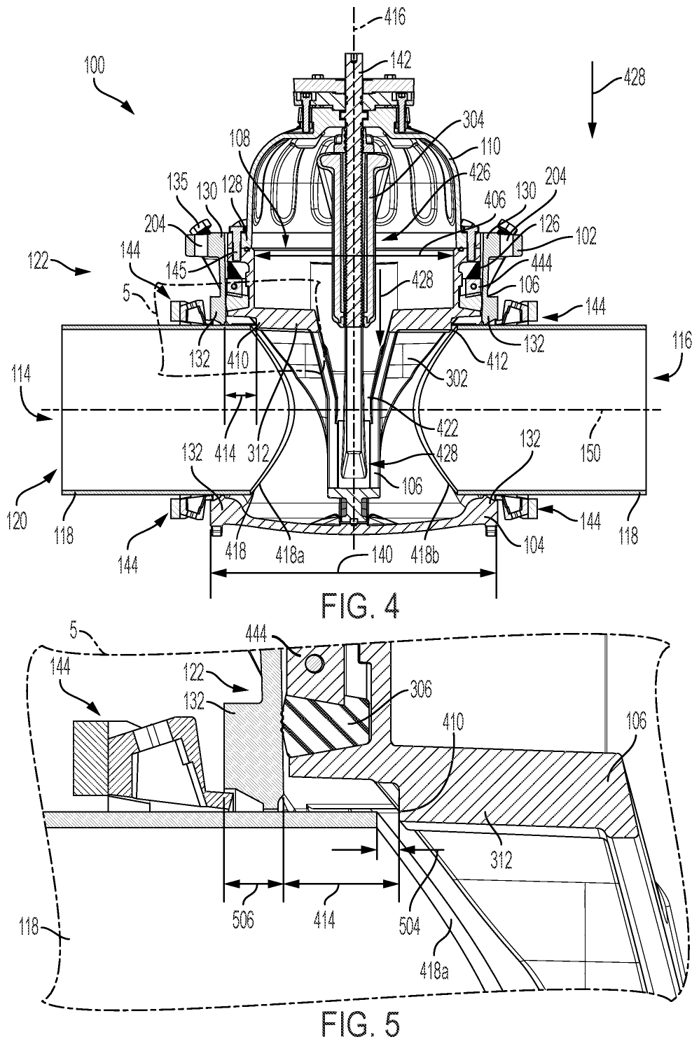

The monolithic bridge 132 extends between the upper pipe flange 131 and the trunk 126 and allows for a reduced branch 115, for example, a reduced distance or thickness between the upper pipe flange 131 and the trunk 126. The reduced distance across monolithic bridge 132 (e.g., the thickness 506 of monolithic bridge 132 shown in FIG. 5) strengthens the upper pipe flange 131 and reduces the capability of pipe 118 to generate a moment or bending force that may pry the upper casing 102 from the lower casing 104.

Reducing the lay-length 140 of insertion valve 100 can reduce the cost of installation and maintenance of insertion valve 100 since the area required to be accessible for installation of the insertion valve 100 can be reduced as measured along an axial length of pipe 118 (axis 150). In addition, reducing the lay-length 140 reduces the bending forces the pipe 118 exerts on the joint between the upper casing 102 and the lower casing 104. Longer monolithic bridges 132 can become susceptible to prying by the pipe and possible leaks from the separation of the upper casing 102 relative to the lower casing 104. By reducing the lay-length 140, the length of the lever in pipe 118 can be reduced, and the prying force generated separating the upper casing 102 from the lower casing 104 can be reduced. Thus, the reduced lay-length 140 of the valve body 122 due to the monolithic bridge 132 enhances the sealing capacity and endurance of the valve body 122.

The attachment flange 130 comprises alternating angled holes 202 and vertical holes 204, and during installation, the cutting assembly is coupled to the attachment flange 130 at the vertical holes 204. As described briefly above, the cartridge assembly 112 comprises a bonnet 110 coupled to a lower cartridge body 302. The bonnet 110 defines a bonnet flange 128 that couples the bonnet 110 to the lower cartridge body 302. Similarly, upper casing 102 can comprise trunk 106, defining an attachment flange 130, and a trunk bore 108. The trunk bore 108 of trunk 106 receives cartridge assembly 112 comprising the bonnet 110 coupled to the lower cartridge body 302 (FIG. 3) to form the completed insertion valve 100.

When installing the insertion valve 100, the attachment flange 130 of the tapping sleeve (e.g., valve body 122) attaches to the cutting assembly (e.g., a knife gate valve on which a cutting assembly can be mounted). The cutting assembly is configured to cut pipe 118 and install insertion valve 100. To do this, the cutting assembly couples to vertical holes 204 of the attachment flange 130. The vertical holes 204 are used to couple to a knife gate valve. The knife gate valve facilitates attaching the cutting assembly and later installing the cartridge assembly 112 in the valve body 122, all while pipe 118 is filled with fluid. When the installation is complete, the bolts holding the knife gate can be removed through the vertical holes 204.

Once the cartridge assembly 112 is installed, the angled bolts 135 (FIGS. 1 and 4) pass through the angled holes 202 and hold down the cartridge assembly 112, as illustrated in the cross-section of FIG. 4. That is, when the cartridge assembly 112 is inserted into the valve body 122, the angled bolts 135 pass through the angled holes 202 to restrain the cartridge assembly 112.

FIG. 3A shows a cartridge assembly 112, and FIG. 3B is an exploded perspective view of the cartridge assembly 112. FIGS. 3A and 3B show bonnet 110, stem 142, lower cartridge body 302, gate 304, and interlocking gasket 310. The interlocking gasket 310 comprises an annular seal component 306, and a wedge seal component 308.

With reference to FIGS. 1-3B, various features of the bonnet 110, the upper casing 102, and the lower casing 104 are apparent. Specifically, stem 142 passes through bonnet 110 and couples to gate 304. The cartridge assembly 112 can thus be inserted within insertion valve 100 to install an operational gate valve (e.g., comprising gate 304 within the cartridge assembly 112) within insertion valve 100, for example, to install a new insertion valve 100 on a previously installed pipe 118.

A fluid bore 320 extends through the cartridge assembly 112 to facilitate fluid flow through the fluid bore 320 when insertion valve 100 is in an open configuration. Similarly, gate 304 can move or translate through a gate channel 322 of cartridge assembly 112 to move insertion valve 100 into a closed configuration. That is, gate 304 is movable between the open configuration and the closed configuration and vice versa. Lower lip 206 captures gate 304 in the closed configuration and/or secures the proper placement of the lower cartridge body 302 to form a fluid-tight seal in valve body 122 formed between upper casing 102 and lower casing 104.

The interlocking gasket 310 couples to the cartridge assembly 112 and provides a seal between the lower cartridge body 302 and the upper casing 102 and lower casing 104 of valve body 122. The annular seal component 306 and the wedge seal component 308 can be joined to form the interlocking gasket 310 that is coupled to the lower cartridge body 302 of the cartridge assembly 112. In this way, lower cartridge body 302 is sealed within insertion valve 100, and when gate 304 is closed, the insertion valve 100 and lower cartridge body 302 are fluidly sealed. In various aspects and as described below, tongues 312 prevents pipe 118 from axial translation into lower cartridge body 302.

When pipe 118 is cut, a coupon (not shown) is removed and discarded. The process creates two new cut pipe ends 418a,b (FIG. 4) within valve body 122. In some aspects, cut pipe end 418a can be near inlet 114, and cut pipe end 418b can be near outlet 116 (or vice versa). Tongues 312 comprising inlet boss 410 and outlet boss 412 are disposed on either side of the lower cartridge body 302 adjacent to pipe ends 418a,b to restrain the pipe end 418 (e.g., against a boss 410,412 shown in FIG. 4).

The interaction of pipe ends 418a,b against the bosses of the tongues 312 restrains pipe 118 from moving axially along pipe axis 150 into the lower cartridge body 302. In other words, lower cartridge body 302 can comprise two tongues 312 (e.g., disposed near the inlet 114 and near the outlet 116), which restrain the pipe end of pipe 118 and prevents the axial movement or translation of pipe 118 into the operational area of gate 304. In some aspects, the tongues 312 are monolithic with the lower cartridge body 302, strengthening the stopping ability of the tongues 312, and extend radially inward of the flow channel (e.g., towards axis 150). Tongues 312 can be located opposite and/or on both sides of gate 304.

FIG. 4 is a cross-sectional view of the insertion valve 100 taken along line 4-4 of FIG. 1. The fluid bore 320 (FIG. 3A-B) defines the gate channel 322 (FIG. 3A-B) on the interior of the cartridge assembly 112. Each tongue 312, at the inlet 114 and the outlet 116 sides of the lower cartridge body 302, comprises an end, or boss (e.g., inlet boss 410 and outlet boss 412) that contacts pipe ends 418 and inhibits axial movement of the pipe end 418 along pipe axis 150. The tongues 312, e.g., on the inlet 114 and the outlet 116 sides of the lower cartridge body 302, extend radially inward into the fluid bore 320 (FIG. 3A-B) to prevent the pipe ends 418 from entering the fluid bore 320. Similarly, the tongues 312 extend axially outward (e.g., parallel to axis 150) from the gate channel 322. The tongue 312 can extend from and/or be adjacent to the gate channel 322 and extend to inlet boss 410 on the inlet 114 side and outlet boss 412 on the side of outlet 116.

Upper casing 102 can comprise the inlet boss 410 and/or the outlet boss 412, each defined at the ends of tongues 312, e.g., at the inlet 114 and/or the outlet 116. In various aspects, inlet boss 410 and/or outlet boss 412 can extend radially outward from a central axis 416 of the trunk bore 108 and/or the trunk diameter 138. The inlet boss 410 and/or the outlet boss 412 can extend radially inward, e.g., into the flow path 120, relative to the pipe axis 150 (FIG. 1). Inlet boss 410 and/or outlet boss 412 can be disposed within upper casing 102 within trunk 106.

As described above, tongues 312 interact and/or restrain pipe ends 418 to prevent axial movement of pipe 118 along axis 150 and prevent pipe 118 from moving inward, e.g., into the lower cartridge body 302. When pipe 118 moves inwardly (e.g., into a tongueless lower cartridge body), the pipe-end 136 (e.g., opposite cut pipe end 418) of pipe 118 can move away from other components and/or valves upstream or downstream from the insertion valve 100 and can result in damage or leaks. The trunk bore 108 can define a trunk diameter 406 in the trunk 126 of upper casing 102 that receives the lower cartridge body 302 of the cartridge assembly 112. Lower casing 104 can be disposed opposite upper casing 102 to trap and capture pipe 118 (e.g., tapping sleeve) before cutting and forming the valve body 122 following cutting and removing the pipe coupon of the pipe 118. Tongue 312 can be disposed on cartridge assembly 112 within the upper casing 102 and extend near or adjacent to the trunk diameter 406 of the trunk bore 108. For example, the tongues 312 on either end of the cartridge assembly 112 can be completely within the trunk diameter 406. That is, the tongues 312 can locate inlet boss 410 and outlet boss 412 within a distance (e.g., diameter) that is equal to or less than the trunk diameter 406.

In some aspects, the lay-length 140 can be equal to or less than the sum of the thickness of the monolithic bridges 132 at the inlet 114 and outlet 116 plus the trunk diameter 138. For example, the lay-length 140 can be equal to or less than the trunk diameter 138 plus two times the thickness (e.g., thickness 506 in FIG. 5) of the monolithic bridge 132 (e.g., the sum of the thickness of the monolithic bridge 132 at the inlet 114 plus the outlet 116). A pipe-end distance 414 can be defined as the distance between the inlet pipe flange 131 and the inlet boss 410 and/or the distance between the outlet pipe flange (e.g., the pipe flange 131 at outlet 116) and the outlet boss 412. Proper sealing of the pipe 118 within valve body 122 can be enhanced by maintaining the pipe-end distance 414. For example, the pipe-end distance 414 can be maintained between the inlet pipe flange 131 and the inlet boss 410 by the tongue.

The lower cartridge body 302 can extend through trunk bore 108 of the upper casing 102 into the valve body 122, e.g., from the top of upper casing 102 to the bottom of lower casing 104. In various aspects, gate 304 can slide through lower cartridge body 302 selectively between the open configuration 426 and the closed configuration (shown by arrow 428 of FIG. 4) of insertion valve 100. Lower cartridge body 302 can be coupled to valve body 122, and the stem 142 can move gate 304 from and between the open configuration 426 to the closed configuration (arrow 428) and vice versa. The stem 142 can be attached to an actuation mechanism, such as a hand wheel or gear box, to allow a user to move the gate 304. For example, the upper casing 102 can couple to a hold-down ring 444 to secure the cartridge assembly 112 and the support of lower lip 206 can help restrain the lower cartridge body 302 in the lower casing 104 to secure the cartridge assembly 112 in the valve body 122.

Lower cartridge body 302 can also couple to an interlocking gasket 310 (FIG. 7) of the cartridge assembly 112 to seal the cartridge assembly 112 within the valve body 122. With reference to FIGS. 4 and 7, interlocking gasket 310 can comprise a first annular seal component 306 joined to a second wedge seal component 308. In various aspects, wedge seal component 308 comprises a partial rectangular shape, extending across three sides (e.g., of the four sides of a rectangle or four-sided trapezoid). In various aspects, annular seal component 306 can comprise a groove or notch 714 (FIG. 7). Similarly, wedge seal component 308 can terminate at a head 706 (FIG. 7). Joining the annular seal component 306 with the wedge seal component 308 can create the complete interlocking gasket 310 that seals the lower cartridge body 302 in the valve body 122.

FIG. 5 shows a cross-sectional view of a portion of FIG. 4 in detail 5. With reference to FIGS. 4 and 5 (e.g., detail 5), the angled bolt 135 can be seen pressing on the hold-down ring 444. The hold-down ring 444 can be metal and can extend over and about annular seal component 306. The hold-down ring 444 can have a joint comprising two or more parts joined with fasteners or other mechanical mechanisms. The hold-down ring 444 can define a top-angled surface that receives the end of the angled bolts 135 and securely holds down or compresses the cartridge assembly 112 and lower cartridge body 302. For example, hold-down ring 444 can comprise the top angled surface compressed by the angled bolts 135 and a bottom angled surface that compresses the annular seal component 306 to seal the cartridge assembly 112 against the upper casing 102 of the insertion valve 100 as shown in FIG. 5.

FIG. 5 also shows the alignment of the pipe 118 with bosses of tongue 312. Specifically, the cut pipe end 418a abuts boss 410 to define a small gap 504 at the inlet 114 and the cut pipe end 418b abuts boss 412 to define the small gap 504 at the outlet 116. If pipe 118 moves axially towards the lower cartridge body 302 within valve body 122, the gap 504 closes but the boss 410 (or 412) on tongue 312 prevents the pipe end 418 from entering and/or damaging the lower cartridge body 302. The boss 410 (or 412) on lower cartridge body 302 is aligned with pipe end 418 to define a positive pipe 118 stop for pipe end 418 and maintain the small gap 504 between the pipe end 418 and lower cartridge body 302.

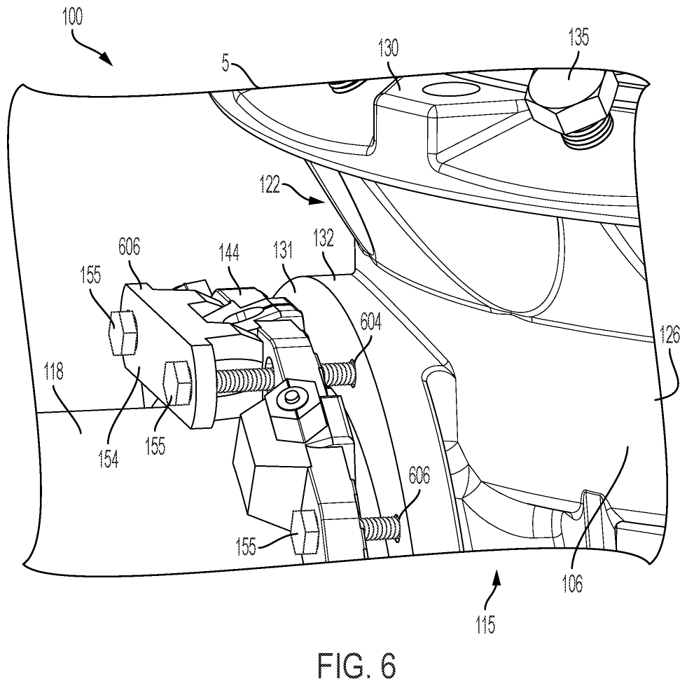

FIG. 6 shows the monolithic bridge 132 interposed between and connecting pipe flange 131 and trunk 106. The monolithic bridge 132 can be formed monolithically between pipe flange 131 and trunk 106 of upper casing 102, such that no joint is created in the upper casing 102. The monolithic bridge 132 can comprise blind fastener holes 604. Blind fastener holes 604 can reduce the lay-length 140 because no fittings (e.g., nuts 125 or T-fittings) are needed on the opposite end of a blind fastener hole, which also eases installation of the restraints 144. Bolt 155 is threadedly engaged with the blind fastener holes 604 without the need for assembly at the opposite side of pipe flange 131. Other holes, such as fastener holes 606 shown in pipe flange 131, can be through holes or blind holes. Specifically, as shown in FIG. 1, the pipe flange 131 can comprise blind fastener holes 606 that threadedly engage bolts 155 to facilitate quicker assembly and reduced lay-length 140. In other aspects, pipe flange 131 (and/or pipe flange 133) may comprise a through hole that extends through the pipe flange 131 and/or pipe flange 133. In this configuration the bolts 155 can be secured without a T-fitting or T-bolt, such as with a nut 125 or other suitable fitting.

With reference to FIGS. 4-6, pipe 118 can be inserted into valve body 122, and trunk 106 abuts monolithic bridge 132. Monolithic bridge 132 connects trunk 106 to pipe flange 131. The joint annular seal component 306 can be sealed by angled bolts 135 extending through the attachment flange 130 to couple the cartridge assembly 112 in the upper casing 102. The angled bolts 135 compress the hold-down ring 444 and compress the joint annular seal component 306 downward to compress the annular seal component 306 against the trunk 106 and seal upper casing 102 against the lower cartridge body 302 of the cartridge assembly 112 when the insertion valve 100 is installed, as illustrated in FIG. 4.

The pipe 118 installed in a spigot (e.g., inlet 114 or outlet 116 of insertion valve 100) can generate bending loads and/or stresses when pipe 118 moves or bends up or down (e.g., along or parallel to trunk axis 152) within the spigot. As described above, tongue 312 can prevent pipe 118 from traveling within the insertion valve 100 and define a limited pipe-end distance 414 for the cut pipe ends 418 to travel. But the cut pipe ends 418 can result in pipe bending that tends to separate the upper casing 102 from the lower casing 104 and may lead to leaks in the valve body 122.

The bending interaction between the branches 115 of the valve body 122 can also create a wedge in the spigot joint 134 that can pry upper casing 102 away from lower casing 104 and may result in cracks and/or leaks in the valve body 122. The limited pipe-end distance 414 within the valve body 122 allowed by the presence of the monolithic bridge 132 can reduce those prying forces generated at small gap 504, for example, between the pipe-end 136 and tongue 312. In addition, limiting a moment arm or thickness 506 of monolithic bridge 132 can be defined between trunk 106 and an outer face of monolithic bridge 132. The reduced thickness 506 can help reduce the prying action the pipe ends 418 generate on valve body 122, e.g., between upper casing 102 and lower casing 104.

Directly attaching the trunk 106 of valve body 122 to the pipe flange 131 with the monolithic bridge 132 can reduce the overall lay-length 140. The reduced lay-length 140 can make insertion valve 100 easier to install and/or reduce the prying force that pipe 118 can generate to separate the upper casing 102 from the lower casing 104. These features can enhance the sealing properties of the valve body 122 with the monolithic bridge 132 being directly coupled to trunk 106, so there is no gap between pipe flange 131 and trunk 106. Blind bolts 155 can be used to reduce lay-length 140; e.g., bolt 155 is not fastened to a nut but is tightened with threads within the spigot joint 134.

With reference to FIGS. 1 and 6, the restraint 144 forms a split mechanical joint restraint assembly that facilitates attachment without requiring a fitting near or adjacent to the valve body 122. One benefit of this design is that the lay-length 140 can be reduced, and an operator can use a blind fastening arrangement to couple the restraint 144 to the monolithic bridge 132. The operator does not need to attach a nut or other T-fitting or T-bolt to the backside of bolt 155 to securely attach the mechanical joint restraint to the monolithic bridge 132 of the valve body 122. In some aspects, pipe flange 131 can comprise a blind fastener. This configuration can reduce tools, hardware, and installation time. The lay-length 140 of the insertion valve 100 can also be reduced since the monolithic bridge 132 can be coupled to the trunk 106 of the valve body 122.

Various blind fastener holes 604 can be threaded to couple the restraint 144 to the monolithic bridge 132. For example, fasteners (shown as bolts 155) can pass through the restraint 144 and securely fasten with threads within the blind fastener holes 604 (or fastener holes 606) to attach the 144 to the monolithic bridge 132. In some aspects, the monolithic bridge 132 of the valve body 122 (e.g., upper casing 102 and/or lower casing 104 of FIG. 1) comprises blind fastener holes 604 that do not pass entirely through the monolithic bridge 132. That is, the bolts 155 can pass entirely through the restraint 144 and terminate, without using a nut or other attachment, within the threading of the blind fastener hole 604. The blind fastener holes 604 are configured to receive studs of bolts 155, instead of using a T-bolt or nut, to securely fasten restraint 144 to the monolithic bridge 132 of the valve body 122.

An extension, or retainer 154, can attach the mechanical joint formed between the restraint 144 and the monolithic bridge 132. For example, as shown at the top of the monolithic bridge 132 of upper casing 102, the retainer 154 couples blind fasteners, e.g., bolts 155, through blind fastener holes 604 and secures the shaft of bolt 155 to the monolithic bridge 132.

FIG. 7 is a perspective view of lower cartridge body 302 of insertion valve 100 (FIG. 1) that can be equipped with interlocking gasket 310 that can comprise two separable components: annular seal component 306 joined to wedge seal component 308. Creating an interlocking gasket 310 from two separable components can help manufacture a large gasket to seal a large joint. For example, the annular seal component 306 can be molded separately from the wedge seal component 308. Then, the two separable components can be joined, making an interlocking gasket 310. The designed joint enhances fabrication and enables a fluid-tight seal when the annular seal component is joined to the wedge seal component to create interlocking gasket 310.

Annular seal component 306 can comprise notch 714 on a radially inward surface of the annular seal component 306. Notch 714 captures head 706 and a neck 708 of wedge seal component 308 to seal the joint and form interlocking gasket 310. Neck 708 couples to head 706 and changes the direction of wedge seal component 308 to wrap around annular seal component 306 to a longitudinal projection 710. In some aspects, a pair of notches 714 on annular seal component 306 are disposed on radially inward surfaces (e.g., on diametrically opposite sides) to capture a pair of T-shaped heads 706 on the wedge seal component 308. The pair of heads 706 are located at both ends of the wedge seal component 308, which extends on three sides of a rectangular pattern, and the pair of heads 706 extend at least partially towards each other in the fourth direction.

Wedge seal component 308 can comprise two longitudinal projections 710 and one transverse projection 712 interconnected between the two longitudinal projections 710. Wedge seal component 308 can fully extend on 3 of the four sides of a rectangular pattern and partially extend from neck 708 to head 706 along the fourth direction of the rectangular pattern. The pair of longitudinal projections 710 extend from the ends of the transverse projection 712 and can resemble a rectangular pattern. In some aspects, wedge seal component 308 can be trapezoidal, and the two longitudinal projections 710 extend at acute or obtuse angles from opposite ends of the transverse projection 712. The heads 706 can be located at the end or terminus of the longitudinal projections 710 and can be used to couple the longitudinal projection to the annular seal component 306 of interlocking gasket 310. That is, head 706 and/or neck 708 at the terminus of each longitudinal projection 710 can be inserted into a groove (e.g., notch 714) within annular seal component 306 to join and couple the wedge seal component 308 to the annular seal component 306 and form the multi-component interlocking gasket 310 capable of forming a fluid-tight seal on valve guide 422.

When gate 304 (FIGS. 3A-4) of valve guide 422 is in an open configuration 426, fluid can flow through the insertion valve 100 along flow path 716. A track 718 can be installed, either within valve guide 422 or within trunk 106 of valve guide 422 (e.g., that can be installed in valve guide 422), to guide gate 304 from the open configuration 426 to the closed configuration (indicated by arrow 428) and vice versa (see FIG. 4).

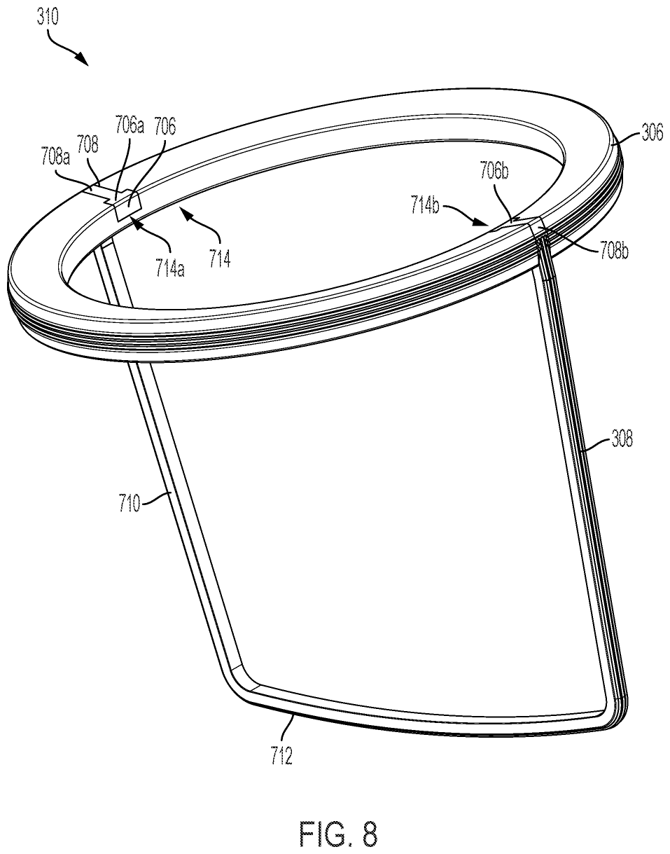

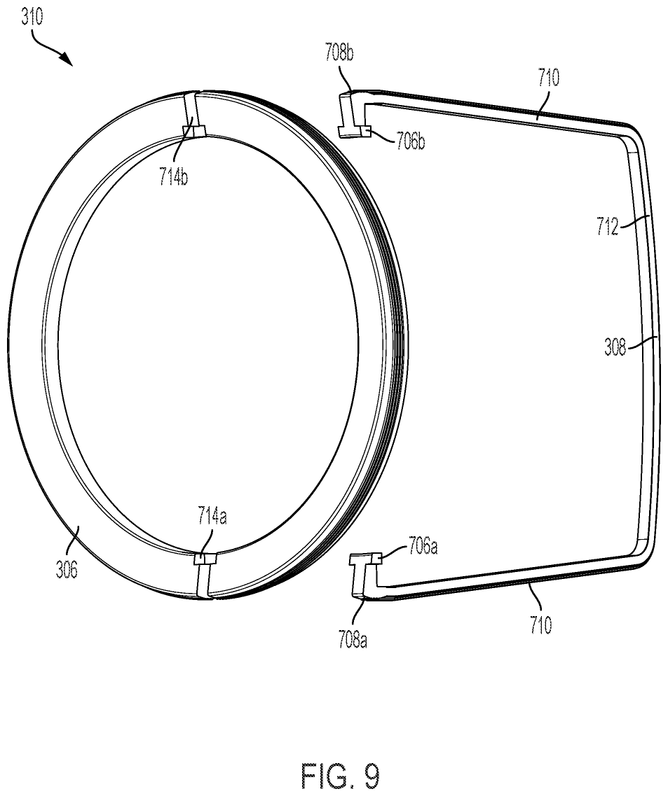

FIG. 8 is a perspective view of an assembled interlocking gasket 310 for the lower cartridge body 302 of valve guide 422 (FIGS. 3A-4). FIG. 9 is an exploded view of interlocking gasket 310 of FIG. 8.

Regarding FIGS. 8 and 9, head 706 and/or neck 708 can fit within notch 714 to form a fluid-tight interlocking gasket 310. Interlocking gasket 310 can comprise annular seal component 306 joined to wedge seal component 308, and the seating of head 706 and neck 708 within notch 714 can create fluid-tight interlocking gasket 310. In various aspects, the annular seal component 306 and/or the wedge seal component 308 are continuous, whereas the interlocking gasket 310 comprises two or more components (e.g., the annular seal component 306 and the wedge seal component 308). For example, interlocking gasket 310 comprises annular seal component 306 comprising a first notch 714a diametrically opposed from a second notch 714b. Wedge seal component 308 comprises first head 706a and a first neck 708a coupled to first notch 714, and second head 706b, and second neck 708b coupled to second notch 714b.

Annular seal component 306 and/or wedge seal component 308 can be rubber and/or encapsulate a metal wire or rod as a continuous monolithic part. The metal wire or rod can enhance the rigidity of the rubber. For example, wedge seal component 308 can be a monolithic part extending from first head 706a comprising a first neck 708a located opposite the second head 706b comprising a second neck 708b.

The description is provided as an enabling teaching of the present devices, systems, and/or methods in their best, currently known aspect. To this end, those skilled in the relevant art will recognize and appreciate that many changes can be made to the various aspects described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

As used throughout, the singular forms “a,” “an,” and “the” include plural referents unless the context clearly dictates otherwise. Thus, for example, reference to a quantity of one of a particular element can comprise two or more such elements unless the context indicates otherwise. In addition, any of the elements described herein can be a first such element, a second such element, and so forth (e.g., a first widget and a second widget, even if only a “widget” is referenced).

Ranges can be expressed herein as from “about” one particular value, and/or to “about” another particular value. When such a range is expressed, another aspect comprises from the one particular value and/or to the other particular value. Similarly, when values are expressed as approximations, by use of the antecedent “about” or “substantially,” it will be understood that the particular value forms another aspect. It will be further understood that the endpoints of each of the ranges are significant both in relation to the other endpoint, and independently of the other endpoint.

For purposes of the current disclosure, a material property or dimension measuring about X or substantially X on a particular measurement scale measures within a range between X plus an industry-standard upper tolerance for the specified measurement and X minus an industry-standard lower tolerance for the specified measurement. Because tolerances can vary between different materials, processes and between different models, the tolerance for a particular measurement of a particular component can fall within a range of tolerances.

As used herein, the terms “optional” or “optionally” mean that the subsequently described event or circumstance may or may not occur, and that the description comprises instances where said event or circumstance occurs and instances where it does not.

The word “or” as used herein means any one member of a particular list and also comprises any combination of members of that list. The phrase “at least one of A and B,” as used herein, means “only A, only B, or both A and B”; while the phrase “one of A and B” means “A or B.”

As used herein, unless the context clearly dictates otherwise, the term “monolithic” in the description of a component means that the component is formed as a singular component that constitutes a single material without joints or seams.

To simplify the description of various elements disclosed herein, the conventions of “left,” “right,” “front,” “rear,” “top,” “bottom,” “upper,” “lower,” “inside,” “outside,” “inboard,” “outboard,” “horizontal,” and/or “vertical” may be referenced. Unless stated otherwise, “front” describes that end of the seat nearest to and occupied by a user of a seat; “rear” is that end of the seat that is opposite or distal the front; “left” is that which is to the left of or facing left from a person sitting in the seat and facing towards the front; and “right” is that which is to the right of or facing right from that same person while sitting in the seat and facing towards the front. “Horizontal” or “horizontal orientation” describes that which is in a plane extending from left to right and aligned with the horizon. “Vertical” or “vertical orientation” describes that which is in a plane that is angled at 90 degrees to the horizontal.

One should note that conditional language, such as, among others, “can,” “could,” “might,” or “may,” unless specifically stated otherwise, or otherwise understood within the context as used, is generally intended to convey that certain aspects include, while other aspects do not include, certain features, elements and/or steps. Thus, such conditional language is not generally intended to imply that features, elements, and/or steps are in any way required for one or more particular aspects or that one or more particular aspects necessarily comprise logic for deciding, with or without user input or prompting, whether these features, elements and/or steps are included or are to be performed in any particular aspect.

It should be emphasized that the above-described aspects are merely possible examples of implementations, merely set forth for a clear understanding of the principles of the present disclosure. Many variations and modifications may be made to the above-described aspect(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

That which is claimed is:

1. An insertion valve comprising:
a first casing comprising a trunk defining a trunk bore, the trunk bore defining a diameter;
a second casing opposite the first casing; and
a cartridge comprising a boss located within the trunk bore of the first casing.

2. The insertion valve of claim 1, wherein the boss is an inlet boss disposed on an inlet side of the cartridge, and further comprising an outlet boss disposed on an outlet side of the cartridge.

3. The insertion valve of claim 2, further comprising an inlet pipe defining an inlet pipe end and an outlet pipe defining an outlet pipe end, wherein the inlet pipe end abuts the inlet boss, and the outlet pipe end abuts the outlet boss, and wherein the cartridge further comprises a bonnet, a lower cartridge body attached to the bonnet, and a gate configured to move within the lower cartridge body and the bonnet between a closed orientation and an open orientation, and wherein the inlet boss is configured to prevent contact between the inlet pipe end and the gate and the outlet boss is configured to prevent contact between the outlet pipe end and the gate.

4. The insertion valve of claim 1, wherein the boss is defined by a monolithic tongue that is monolithic with a lower cartridge body of the cartridge assembly.

5. The insertion valve of claim 4, wherein the monolithic tongue extends adjacent to the diameter of the trunk bore.

6. The insertion valve of claim 1, wherein the boss extends radially outward from a central axis of the diameter defined by the trunk bore.

7. The insertion valve of claim 1, wherein the boss extends radially inward into a flow path defined by the first casing and the second casing.

8. The insertion valve of claim 1, wherein the boss is disposed on a lower cartridge body of the cartridge and the cartridge is inserted within the trunk.

9. The insertion valve of claim 1, wherein the cartridge is restrained within the trunk, and the boss is monolithically defined on the cartridge.

10. The insertion valve of claim 1, further comprising angled fasteners that restrain the cartridge within the trunk of the first casing.

11. An insertion valve comprising:
a first casing comprising:
a trunk surrounding a trunk bore; and
a monolithic bridge coupled to the trunk; and
a second casing opposite the first casing.

12. The insertion valve of claim 11, wherein the first casing and the second casing define a lay-length is equal to or less than two times a thickness of the monolithic bridge plus a diameter of the trunk bore.

13. The insertion valve of claim 11, wherein:
the monolithic bridge is an inlet monolithic bridge,
the first casing defines an outlet monolithic bridge coupled to the trunk,
the first casing is coupled to the second casing to create a valve body comprising an inlet pipe flange and an outlet pipe flange, and
the inlet monolithic bridge reinforces the inlet pipe flange and the outlet monolithic bridge reinforces the outlet pipe flange.

14. The insertion valve of claim 11, wherein the first casing defines an upper pipe flange and the monolithic bridge is monolithically formed with the upper pipe flange and the trunk of the first casing.

15. The insertion valve of claim 11, wherein a valve body is formed when the first casing is coupled to the second casing to form a bell and spigot joint and define a lay-length, and wherein the lay-length is equal to or less than a diameter of the trunk bore plus two times a thickness of the monolithic bridge and the bell and spigot joint restrains a pipe-end.

16. The insertion valve of claim 11, wherein the monolithic bridge directly couples to the trunk, and the trunk comprises an attachment flange.

17. The insertion valve of claim 11, further comprising a restraint coupled to the monolithic bridge with at least one blind mechanical fastener.

18. The insertion valve of claim 17, wherein the restraint comprises two halves, and wherein both halves of the restraint are coupled to the monolithic bridge.

19. The insertion valve of claim 18, wherein a retainer couples the halves of the restraint to the monolithic bridge with the at least one blind mechanical fastener.

20. The insertion valve of claim 18, wherein the retainer couples the halves of the restraint to a first flange of the first casing and a second retainer couples the halves of the restraint to a second flange of the second casing.

21. An interlocking gasket comprising:
an annular seal component comprising a first notch diametrically opposed from a second notch; and
a wedge seal component comprising a first head coupled to the first notch and a second head coupled to the second notch.

22. The interlocking gasket of claim 21, wherein the annular seal component is a continuous monolithic part.

23. The interlocking gasket of claim 21, wherein the wedge seal component is a monolithic part extending from the first head located opposite the second head.

24. The interlocking gasket of claim 21, wherein the wedge seal component further comprises a first neck coupled to the first head and a second neck coupled to the second head; and wherein the first neck is coupled to the first notch of the annular seal component and the second neck is coupled to the second notch of the annular seal component.

25. An insertion valve comprising:
a first casing comprising a trunk;
a second casing opposite the first casing;
a cartridge assembly extending inside the first casing and the second casing; and
an interlocking gasket coupled to and sealing the cartridge assembly within the first casing and the second casing, the interlocking gasket comprising an annular seal component comprising a notch joined to a head of a wedge seal component to create the interlocking gasket.

26. The insertion valve of claim 25, wherein the notch is a first notch and the head is a first head, and wherein the first head of the wedge seal component is coupled to the first notch of the annular seal component, and a second head of the wedge seal component is coupled to a second notch of the annular seal component.

27. The insertion valve of claim 25, wherein the head is a first head, and the wedge seal component is a monolithic part that extends continuously from the first head to a second head, and the annular seal component is continuous and monolithic.

28. The insertion valve of claim 27, wherein:
the cartridge assembly comprises a lower cartridge body, a bonnet coupled to the lower cartridge body, a stem, and a gate coupled to the stem,
the gate is movable by the stem between an open configuration and a closed configuration within the lower cartridge body and the bonnet,
the cartridge body extends through a trunk bore of the trunk, and
the interlocking gasket seals the lower cartridge body against the first casing and the second casing.
